(19) United States
(12) Patent Application Publication
(10) Pub. No.: US 2008/0018115 A1
(43) Pub. Date: Jan. 24, 2008

(54) SEMI-SUBMERSIBLE HYDROELECTRIC POWER PLANT

(75) Inventor: Sergey A. ORLOV, London (CA)

Correspondence Address: BAKER & MCKENZIE LLP;PATENT DEPARTMENT, 2001 ROSS AVENUE, SUITE 2300, DALLAS, TX, 75201, US

(73) Assignee: Boray Technologies, Inc., London (CA)

(21) Appl. No.: 11/458,912

(22) Filed: Jul. 20, 2006

(51) Int. Cl. F03B 13/00

(52) U.S. Cl. 290/54

(57) ABSTRACT

An apparatus configured to convert kinetic energy of water flow to electrical power. The apparatus includes an axial turbine that is designed to be submerged under a water surface and a shaft that extends from the axial turbine. The shaft is designed to extend above the water surface and provide buoyancy. The apparatus may be designed such that a waterline area of the apparatus is less than a predetermined multiplier times the displacement of the apparatus divided by the length of a wave having a low probability of occurring. In a particular case, the predetermined multiplier may be approximately five and the wave having a low probability may be a characteristic wave of approximately 3% probability. A plurality of such apparatuses may be arranged in a plurality of rows defining a system, such that an upstream apparatus does not overlap a downstream apparatus in projection to a plane transverse to the water flow.

### TECHNICAL FIELD

The present invention relates to systems and methods for power generation from the kinetic energy of ocean currents, and more specifically, to semi-submersible hydroelectric power generating plants.

### BACKGROUND

Kinetic energy of ocean currents represents a promising source of clean renewable energy that provides a number of advantages in terms of effective practical power generation.

The global ocean is characterized by steady three-dimensional motion of water masses, including surface ocean currents, which can represent stable patterns of flow in ocean basins between continents.

Typical surface ocean currents feature a high velocity stream arranged at or near the ocean surface. As such, ocean currents resemble a river flowing within an ocean. The currents generally have a relatively compact energy-bearing core or layer near the surface. Accordingly, kinetic energy extraction and power generation from ocean currents can be convenient and does not require the use of deep-water devices.

For at least this reason, ocean currents are more suitable for practical and efficient power generation in comparison with conventional renewables that are currently under development and exploration, including wind, ocean waves, solar energy, and tidal currents.

The main disadvantages of such conventional sources of energy are that they are rather unpredictable (wind, ocean waves, solar energy), or can provide only periodic generation of electricity (only two times a day in the case of tidal currents and only during day time in the case of solar energy). As an obvious example, wind frequently changes direction and can quickly change from dead calm to hurricane gusts. These wide variations in power availability represent highly probabilistic processes. Accordingly, currently operating wind energy units generate, on average, only a fraction of electricity compared to their nominal power.

The average energy density of these conventional sources is also relatively low. Low concentration or energy density (W/m²) leads to a necessity to collect energy from larger areas in order to produce substantial amounts of electricity. Normally, low power density devices are bulky and expensive structures. For example, large rotors may be required on wind turbines, and large footprints may be required for solar photovoltaic elements.

Bulky and expensive power generating devices generally have higher electricity generation costs (due to initial capital costs) and lower profitability. This makes such devices less competitive in comparison to traditional methods of electricity generation based on fossil fuels.

In contrast to the above conventional sources of clean energy, ocean currents, these powerful “rivers in the ocean”, provide a steady and reliable supply of highly concentrated energy. In power terms, ocean currents would be similar to strong winds that blow day-and-night, year round and can have an energy density approximately 10 times higher than average winds. At the same time, the mass density of water is much higher than air, resulting in higher energy densities corresponding to rather moderate velocities (i.e. 2 m/s). These velocities are found in well-know ocean currents, including the Florida Current in the Atlantic basin, and the Kuroshio Current in the Pacific Ocean.

It is clear that ocean currents are highly attractive as a stable and concentrated source of clean renewable energy for electricity generation. Unfortunately, there have been a number of problems in developing power generating devices for capturing this energy.

One of the main problems in exploiting ocean currents effectively is the practical operation of marine turbines under real ocean current conditions. For example, the simplest and the most rational configuration for marine turbines employ a conventional axial turbine with a rotor driving an in-line generator directly or through a gearbox.

Conventional methods that can be applied to generating electricity from ocean currents can be subdivided into three main groups: 1. Power-generating devices (turbines) mounted on the seabed; 2. Devices tethered by ropes affixed to the seabed and hovering in between the seabed and ocean surface; and 3. Devices supported by vessels floating on the ocean surface.

The first group of devices mounted on the seabed have difficulties regarding accessibility and maintainability of the power-generating devices. Further, when dealing with available ocean currents that are most suitable for effective power generation (rather than tidal currents) the energy-saturated layer is arranged closer to the ocean surface. Whereas deeper areas generally have lower velocities and lower energy densities.

While it may be possible to raise the power-generating sets (turbines) of these devices using, for example, long pylons or the like, this solution is not very practical because a typical ocean current being suitable for power generation corresponds to areas of the ocean having depths about 200 m to 700 m. Due to technological and financial limitations in building ocean structures, devices in this first group are generally restricted to relatively shallow tidal currents, but cannot generally be used for power generation on the basis of typical ocean currents.

Tethered hovering devices of the second group also have difficulty with regard to accessibility and maintainability of submerged power-generating devices.

Generators, gearboxes, electrical equipment, pumps, valves, drives, etc., require periodic service and repair. These devices have finite lifetimes and require regular maintenance to continuously operate power-generating devices. Although it is possible to prolong maintenance by means of special technological solutions and materials, eventually, some components will fail if not properly maintained. Furthermore, expensive high-endurance devices increase the cost of the power-generating device, resulting in higher electricity generation costs. Regardless of how long specific parts last, access to submerged portions of the device will be necessary at some point in time.

For most of the devices in the second group, the only practical way to provide regular service and repair is periodic surfacing of the whole device. This generally requires, for example, surfacing tanks with a compressed air system, controllable tether systems, remotely controlled dynamic lift devices (hydrofoils, e.g.), etc. All of which increase system cost and complexity.

Another problem with the group two devices is keeping them in the required position and orientation relative to the current flow and the seabed. Typical solutions include hydrofoils, trimming and ballast tanks, often using complex automatic control devices. This problem is further complicated by the need to ensure stability of the design while hovering and/or raising/lowering during maintenance.

A further problem of stability arises from moments generated by the rotating turbines. As a turbine rotates, it induces a counter moment in the main structure that rotates the structure in the opposite direction. This problem is typically solved by means of side-by-side arrangement of two structurally bound counter-rotating turbines. Opposing torques from each turbine cancel each other to stabilize and cease rotation of the structure.

Designs of the second group can also have a problem with leakage. Even negligible leakage of water into, or leakage of air out of, buoyancy and equipment bearing compartments for a period of time can represent a serious problem, for example, the entire device may sink. In a fully submerged system, bilge pumps alone cannot solve the problem of leakage.

The third group comprises devices supported by vessels floating on the ocean surface. Devices in this group typically include large pontoons or barges floating on the ocean surface that are anchored to the seabed. The floating structures support a power-generating device that extracts energy from ocean currents. While such devices solve the problems of keeping the turbines at the right depth to exploit the most energy-saturated upper layers of ocean surface currents and accessibility and maintainability of power-generating sets, the principal problem with such devices is that bodies floating on the surface are vulnerable to violent forces of nature. In particular, dynamic wind loads from hurricanes and storms can damage anchoring systems, and the dynamic impact of waves can damage the floating structure. Cyclic loading inherent in ocean conditions coupled with high dynamic response of the floating device can also lead to undesirable accelerations of the entire structure and intensified dynamic forces. Both effects may damage the structure and/or equipment.

Generally speaking each of the conventional systems in the above three groups have problems with respect to practicality and efficient power generation under real surface ocean current conditions.

Accordingly, there is a need for systems and methods that allow for generation of electricity from ocean currents that remains relatively simple, reliable and low-cost. There is a need for systems and methods that attempt to overcome at least some of such problems regarding efficiency, accessibility and maintainability of power-generating devices, balance and stability in operational position, and ability to operate effectively under real ocean conditions.

Accordingly, the embodiments described below attempt to overcome at least some of the problems with conventional systems and provide at least some of the benefits described above.

### SUMMARY

According to one aspect, there is provided an apparatus configured to convert kinetic energy of water flow to electrical power. The apparatus includes an axial turbine designed to be submerged under a water surface. The axial turbine includes a rotor, an enclosure, and a generator within the enclosure coupled to the rotor. The apparatus also includes a shaft extending from the enclosure and an anchor system connecting the apparatus to a stationary reference. The shaft is configured to extend above the water surface and provide buoyancy.

The provision of a shaft extending from the enclosure of the axial turbine to above the water surface is intended to provide efficient access to the generator for maintenance purposes and the like.

In a particular case, the apparatus may be configured to have a waterline area at the water surface that is less than a predetermined multiplier times the displacement of the apparatus divided by the length of a wave having a low probability of occurring. In this case, the predetermined multiplier may be approximately five and the wave having a low probability may be a characteristic wave of approximately 3% probability. Configuring the apparatus in this manner is intended to enhance stability of the apparatus.

In another aspect, there is provided an apparatus configured to convert kinetic energy of water flow to electrical power. The apparatus includes a pair of axial turbines configured to be submerged under a water surface. The pair of axial turbines have parallel axes of rotation and are counter-rotating. Each axial turbine includes a rotor, an enclosure, and a generator within the enclosure coupled to the rotor. The apparatus also includes a central bridge structure interconnecting the pair of axial turbines, at least two shafts, and an anchor system connecting the apparatus to a stationary reference. Each of the at least two shafts attaches to a respective axial turbine and is configured to extend above the water surface such that the at least two shafts provide buoyancy.

In a particular case, the apparatus may include a first pair of access shafts and a second pair of access shafts that extend from the enclosures. The first pair of access shafts being placed symmetrically about a first plane through the center of gravity of the apparatus. The second pair of access shafts being placed symmetrically about a second plane through the center of gravity of the apparatus. The configuration of the access shafts is intended to enhance the stability of the apparatus.

In another aspect, there is provided a system configured to convert kinetic energy of water flow to electrical power. The system includes a plurality of apparatuses configured to convert kinetic energy of water flow to electrical power, for example, as described above. The plurality of apparatuses are arranged in a plurality of rows such that an upstream apparatus of an upstream row does not overlap a downstream apparatus of a downstream row in projection to a plane transverse to the water flow.

According to another aspect, there is provided a method of designing an apparatus to be semi-submerged on a water surface. The method includes: providing the apparatus with a center of gravity below a center of buoyancy of the apparatus; and providing the apparatus with a waterline area that is less than a predetermined multiplier times the displacement of the apparatus divided by the length of a wave having a low probability of occurring. In particular, the predetermined multiplier may be approximately five and the wave having a low probability may be a characteristic wave of approximately 3% probability.

### BRIEF DESCRIPTION OF THE DRAWINGS

The embodiments will now be described by way of example only with reference to the following drawings, in which:

FIG. 1 is a perspective view of a semi-submersible power plant according to an exemplary embodiment;

FIG. 2 is a vertical along-the-flow section of the semi-submersible power plant of FIG. 1;

FIG. 3 is a transverse-to-the-flow section of the semi-submersible power plant of FIG. 1, showing access shafts mounted atop nacelles, an angled central bridge structure and inclined braces;

FIG. 4 is a horizontal cross-section of an access shaft having a fairing;

FIG. 5 is a transverse-to-the-flow section of an alternative embodiment of a semi-submersible power plant, showing side access shafts, a straight central bridge structure, vertical central strut and inclined braces;

FIG. 6 is a transverse-to-the-flow section of an alternative embodiment of a semi-submersible power plant, showing access shafts mounted atop nacelles, a straight central bridge structure interconnecting the nacelles, and a central vertical strut with an above water structure providing connection between upper housings;

FIG. 7 is a cross-section of a central bridge structure comprising three tubular structural elements including two side tubes, wherein the two side tubes serve as ballast tanks, and one central tube representing a tunnel for interconnecting nacelles, the tubes having upper and lower panels covering gaps between tubes, and an aft fairing on the aft-most tube;

FIG. 8 is a perspective view of an alternative embodiment of a semi-submersible power plant having forward-mounted turbines and a central mooring sprit structure intended for connection to a single anchoring system;

FIG. 9 is a perspective view of an alternative embodiment of a semi-submersible power plant having forward-mounted turbines and aft stabilizers;

FIG. 10 is a perspective view of an alternative embodiment of a semi-submersible power plant having forward-mounted turbines and lateral mooring wings intended for connection to two anchors;

FIG. 11 is a perspective view of an alternative embodiment of a semi-submersible power plant having aft-mounted turbines and anchored in the flow with a mooring system of wishbone configuration comprising an intermediate buoy and two mooring lugs on a central bridge structure;

FIG. 12 is a perspective view of an alternative embodiment of a semi-submersible power plant anchored in the flow with forward and aft, center plane, mooring systems provided with intermediate buoys;

FIG. 13 is a perspective view of an alternative embodiment of a semi-submersible power plant having two lateral mooring wings and anchored in the flow with four anchors provided with intermediate buoys; and

FIG. 14 is a plan view of an offshore hydropower station with semi-submersible power plants arranged in a stagger formation.

### DETAILED DESCRIPTION

Referring now in greater detail to the drawings, wherein illustrations are for the purpose of describing exemplary embodiments only and not for the purpose of limitation, illustrated therein are exemplary embodiments of systems for exploitation of kinetic energy of ocean surface currents. In particular, the drawings illustrate exemplary embodiments of a semi-submersible power plant.

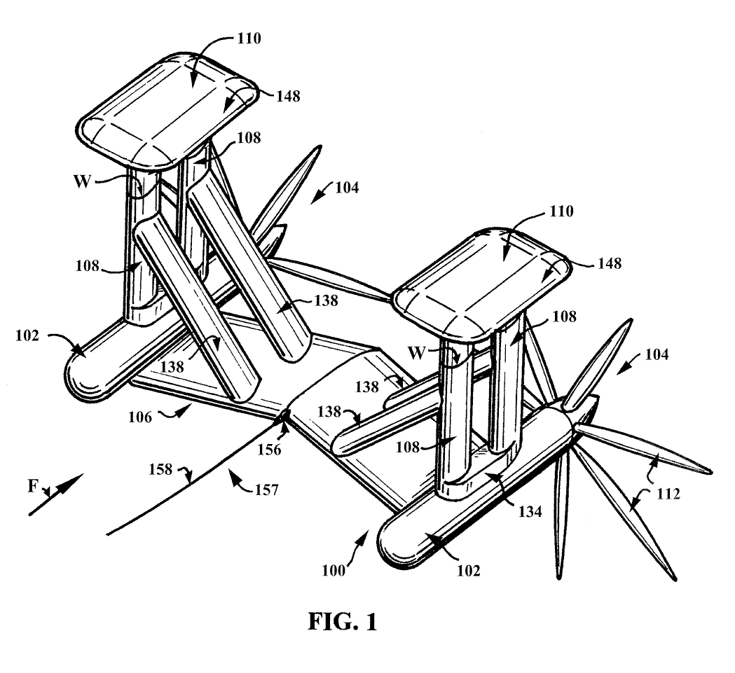

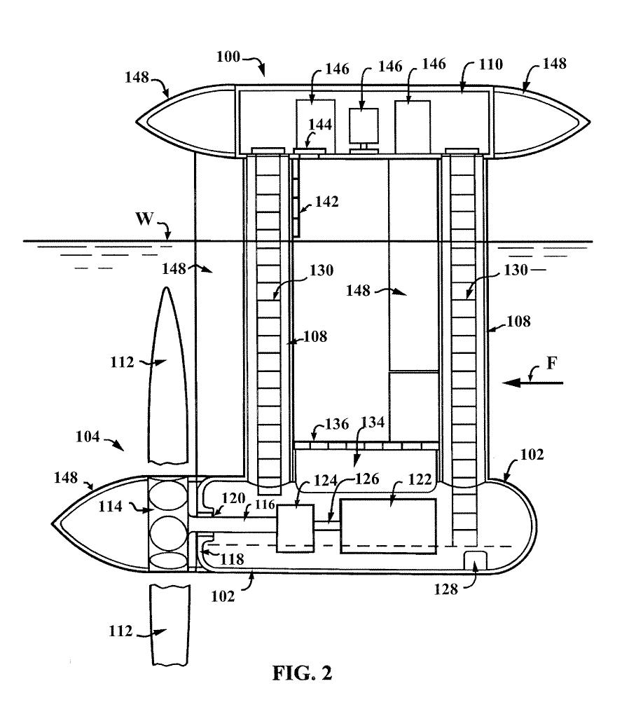

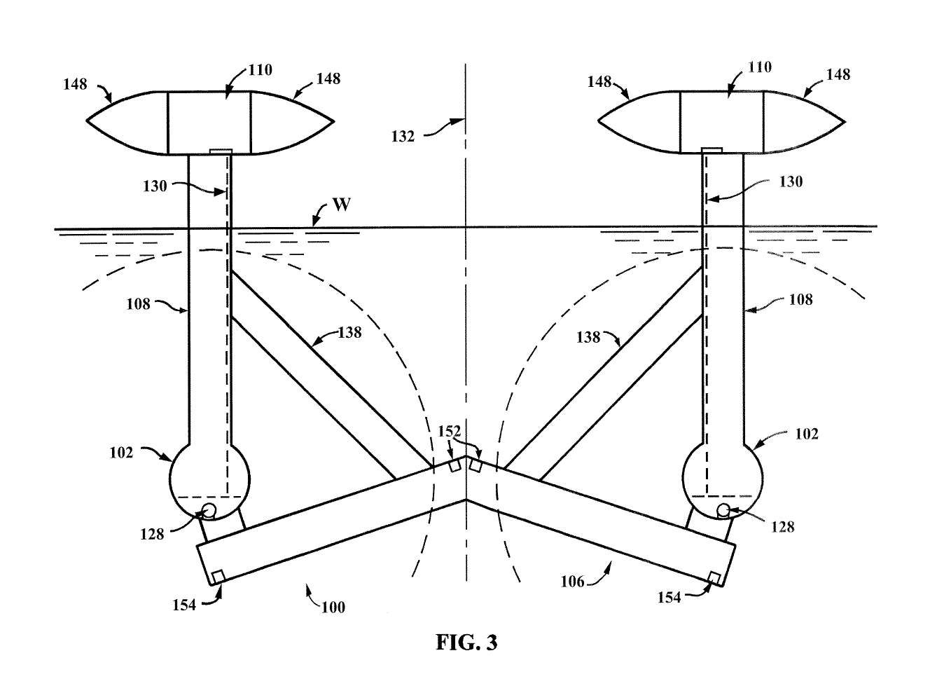

FIG. 1 shows a perspective view of a first exemplary embodiment of a semi-submersible power plant 100. FIG. 2 and FIG. 3 are cross-sections taken at a plane along-the-flow, and at a plane transverse-to-the-flow, respectively. In FIGS. 1 and 2, the direction of the flow of the ocean surface current is indicated by the arrow F and also corresponds to the longitudinal direction.

The semi-submerged power plant 100 includes two submerged nacelles 102 (each nacelle provided with an aft mounted turbine 104), a central bridge structure 106, four access shafts 108, and two upper housings 110. Upper housings 110 comprise an upper unit of power plant 100, while nacelles 102, turbines 104 and central bridge structure 106 comprise a lower unit of power plant 100.

In operation, nacelles 102 are intended to be submerged below the waterline W and support turbines 104 such that the turbines 104 are completely submerged but positioned in the vicinity of the water surface depicted by waterline W. This places turbines 104 in the upper energy-saturated layer of ocean currents. As shown in FIG. 2, each nacelle may also contain a bilge pump 128 to displace any water that may leak into the enclosure. It will be understood that elements of power plant 100 will generally include watertight seals to prevent or reduce the amount of any leakage.

Energy from ocean currents is converted to electricity by turbines 104. Each turbine 104 includes a rotor 114 having blades 112, a low-speed shaft 116, a gearbox 124, a high-speed shaft 126, and a generator 122. Blades 112 extend radially from a hub of rotor 114 to convert flow energy into rotational mechanical energy that causes rotor 114 to spin about a rotational axis. Rotor 114 transmits rotational energy through low-speed shaft 116, which extends along the rotation axis and through an aft bulkhead 118 of nacelle 102. To reduce leakage, a sealed bearing 120 supports low-speed shaft 116 at bulkhead 118. Inside nacelle 102, gearbox 124 transmits rotational energy from low-speed shaft 116 to high-speed shaft 126 while increasing angular speed. High-speed shaft 126 connects to generator 122 to convert rotational energy into electricity. Generator 122 may be, for example, a conventional generator or a multi-pole generator.

Turbines 104 on each nacelle 102 are counter-rotating with their axes arranged along the flow of ocean current F and approximately in the same horizontal plane. In this manner, turbines 104 are arranged symmetrically about a center plane 132 (see FIG. 3) at a distance from each other slightly in excess of the diameter of rotor 114 to provide clearance. Symmetrical placement and counter rotation of turbines 104 increases the stability of power plant 100 by canceling moments generated by the rotation of each respective turbine.

In this embodiment, turbines 104 each include seven blades 112 extending basically normally from the axis of rotation for each turbine 104. Because ocean currents are generally more stable in comparison with winds, turbines 104 can have a higher blade density (i.e. solidity) than the typical three-blade system found on wind turbine rotors in order to enhance extraction of energy from the water flow. Although, each turbine 104 is shown with seven blades 112, the number of blades can be optimized for specific operational conditions.

To facilitate loading and unloading of power-generating equipment into and out of nacelles 102, power plant 100 may be raised within the water to expose nacelles 102. In particular, superstructures 134 are provided to nacelles 102 and have sealed hatches 136 that provide access to the enclosures of nacelles 102 for loading and unloading power-generating equipment when power plant 100 is floated to the surface. Superstructures 134 also raise the freeboard of the surfaced nacelles 102 and enhance stability while loading in rough sea conditions. In the present embodiment, superstructure 134 and hatch 136 are located between the two access shafts 108, which are connected to each nacelle (arranged fore and aft).

In ordinary operation, access shafts 108 extend vertically above the water surface (depicted by waterline W) and connect with upper housings 110. Upper housings 110 are arranged atop access shafts 108 such that when power plant 100 is semi-submerged, upper housings 110 are at a predetermined distance above the waterline W. As shown in FIG. 2, each pair of access shafts 108 that extend from a particular nacelle 102 connects to the same upper housing 110 to provide additional structural stability.

Nacelles 102, central bridge structure 106, access shafts 108 and upper housings 110 form an interconnected rigid structure. Preferably, each element is watertight. In this embodiment, access shafts 108 are hollow and provide an access path from above the water surface to gearbox 124, generator 122, and shafts 116, 126 (sometimes collectively referred to as power-generating equipment) within nacelles 102. These access paths allow servicing and repair to be performed without the need to float power plant 100 (i.e. nacelles 102) to the water surface W. Such arrangement also provides two exits at opposite forward and aft extremes of each nacelle 102 that corresponds to shipbuilding safety rules generally adopted for engine rooms. Access shafts 108 may include ladders 130 and/or elevating devices (not shown) that provide access between nacelles 102 and upper housings 110.

Access shafts 108 are generally hollow and have a vertically submerged dimension not less than the length of a blade 112. This serves the purpose of keeping turbines 104 submerged as well as providing buoyancy to assist in floatation of power plant 100 while maintaining a low dynamic response.

Access shafts 108 can also provide an opening to the atmosphere, allowing bilge pump 128 to effectively displace water from the enclosures of nacelles 102. In previous systems, a compressed air source was necessary to expel water from a fully submerged vessel and prevent siphoning of water back into the vessel. Having a passage from bilge pump 128 to the atmosphere can reduce or remove the need for a compressed air source because bilge pump 128 can displace water directly from the submerged portion without changing the pressure in nacelle 102 or the like.

Arrangement of the typically heavy generator 122 at and in the nacelle 102 (that is, the lower unit) maintains a low center of gravity of power plant 100. In general, the center of gravity should be vertically close to turbine 104 and the center of buoyancy of the lower unit.

The low center of gravity combined with the buoyancy provided by access shafts 108 is designed to position the center of buoyancy for power plant 100 above the center of gravity of power plant 100. By positioning access shafts 108 appropriately along nacelles 102, the center of buoyancy can also be arranged basically along center plane 132 and coincide with the center of gravity in projection to the horizontal plane, this configuration maintains a stable upright position of power plant 100.

The fact that access shafts 108 extend above the water surface W provides additional tilt stability. Nacelles 102 and access shafts 108 are arranged symmetrically about center plane 132 approximately one turbine rotor diameter apart from each other. Accordingly, a list inclination of power plant 100 in the transverse direction will raise one access shaft 108 and lower the other access shaft 108. As power plant 100 tilts, the differential between buoyancy forces of each access shaft 108 and nacelle 102 pair create a moment couple around the center of gravity that restores power plant 100 to its equilibrium position.

Similarly, by constructing power plant 100 with four access shafts 108, pairs of access shafts 108 can also be arranged symmetrically about the center of gravity in both the longitudinal and transverse directions. Such a design provides stability in both the longitudinal and transverse directions.

When semi-submerged, power plant 100 represents an oscillating system having its own natural frequency. Vertical oscillations for power plant 100 can be approximated by using the equation: ω₀²=ρ*g*A/M, where ω₀ is the frequency of vertical oscillations (radians per second); p is the density of water (kg/m³); g=9.81 m/sec² is the acceleration due to gravity; A is a waterline area (m²); and M is a mass of the body (kg). Otherwise stated: ω₀²=g*A/D, where D is a displacement of the body (m³).

As a response to periodic impact of waves, power plant 100 will oscillate vertically with some amplitude (m). The amplitude of the oscillations can be represented by a function of the ratio between the natural frequency and the frequency of wave impacts. Oscillations at some specific amplitude and frequency result in periodic accelerations of power plant 100. Corresponding high amplitudes of acceleration can potentially lead to damage and failure of structures and/or equipment.

A high amplitude and accordingly dangerous operational environment generally correspond to a resonant mode. Resonance occurs when the frequency of wave impacts equals the natural frequency of power plant 100. To reduce oscillation amplitudes, prevent generation of considerable dynamic loads, and improve reliability of power plant 100, the resonant mode should be avoided. This is possible if the natural frequency of power plant 100 is designed to be lower than the frequency of wave impacts under operational conditions.

The frequency of wave impacts for deep water bodies, such as in the case of ocean currents, can be found from the following equation: ω_{w}²=2π*g/λ, where ω_{w} is the frequency of wave impacts (radians per second) and A is the length of a wave (m). In considering ocean waves in engineering applications (i.e. shipbuilding), λ typically represents the length of a wave of 3% probability, characterizing a particular ocean operational site. Waves at a particular ocean site are generally characterized using a probability distribution based on a particular characteristic of the wave. For example, a wave of 3% probability can represent a particular wave where 97% of the waves occurring at the ocean site have a length less than the length of the wave of 3% probability. While the above formulation is used in this embodiment, it may be possible to consider the effect of waves having a different probability of occurring, for example, another standard characteristic used in engineering corresponds to a wave of 1% probability.

Using the above formulation to achieve low dynamic loads and reliable operation of power plant 100, it follows that ω₀ should be lower than ω_{w} during operation. Assuming a minimum frequency reserve (that is, safety margin) of 12%, the maximum natural frequency of the device can be estimated as: ω₀=ω_{w}/1.12. Using the two formulae above yields the following equation: g·A/D=2π·g/1.2544·λ. After simplifying and approximating, the result is: A=5·D/λ. It is possible to derive other formulations that may use different minimum frequency reserves resulting in different predetermined multipliers (for example, predetermined multipliers other than 5). For example, using a minimum frequency reserve of 25%, the result is: A=4·D/λ.

Thus the maximum waterline area of power plant 100 for avoidance of the resonant mode using a practically acceptable 12% frequency reserve is 5·D/λ. Designing power plant 100 in this way results in a lower dynamic response and smaller oscillation amplitudes with respect to wave impacts. Accordingly, power plant 100 operates in a steady and reliable fashion.

As a practical example, consider a power plant of D=1000 m³ displacement operating at an ocean site with waves of 3% probability being A=250 m long. Using the proposed formula, the total waterline area of access shafts 108 should not exceed A=20 m². For a power plant having a total of four tubular access shafts, each access shaft would have a maximum diameter of 2.5 m. This diameter is reasonable for structural purposes as well as when using access shafts 108 for maintenance pathways to the power generating equipment.

Since access shafts 108 can be long and narrow, additional supports may be necessary to reduce elastic deformations, and protect against structural failure. To increase strength and rigidity, braces 138 can connect central bridge structure 106 to access shafts 108. Braces 138 may represent inclined structural elements as shown in FIG. 1. The inclined braces 138 connect close to the center plane 132 on the central bridge structure 106 and approximately halfway up the height of access shafts 108.

In this embodiment, an external ladder 142 is provided on at least one access shaft 108 and an entrance hatch 144 is provided on, for example, the underside of housing 110 to provide access (e.g. from a service boat) to upper housing 110. In this embodiment, upper housing 110 contains electrical equipment 146 (which may include transformers, switchgear and other equipment in electrical communication with the turbine 104). Storing electrical equipment 146 in upper housings 110 permits service and maintenance of such electrical equipment without descending to nacelles 102. Electrical equipment 146 may be used to connect with a power grid (not shown) to distribute electricity to consumers.

In order to avoid potential damage to power plant 100 and electrical equipment 146 due to impact of waves on housings 110, housings 110 can be positioned at an appropriate distance above the water surface.

To reduce wind loads, upper housings 110 can be provided with streamlined profiles or fairings 148. Fairings 148 on upper housings 110 generally include leading and trailing edges that are arranged basically in the same horizontal plane at about half the height of upper housings 110. Providing streamlined profiles around the entire upper housing 110 can reduce wind loads that may cause undesirable horizontal, transverse or vertical motion of power plant 100. Furthermore, fairings 148 can also reduce wind loads transmitted to an anchoring system. In general, fairings 148 can improve the stability of power plant 100.

Although access shafts 108 provide access to nacelles 102 without any change in position of power plant 100, it may be desirable to occasionally bring power plant 100 toward the water surface W. For example, it may be easier to clean or repair blades 112 at the surface. It may also be easier to tow power plant 100 in a surfaced position when positioning, relocating or removing the device after it has completed its lifecycle. To allow bringing power plant 100 toward the water surface, nacelles 102 and/or the central bridge structure 106 can act as or be provided with ballast tanks.

In this embodiment, the interior of the central bridge structure 106 serves as a ballast tank. Under normal operating conditions the volume of central bridge structure 106 will be filled with water to fully submerge turbines 104. By filling the central bridge structure 106 with air, for example, compressed air, the buoyancy of power plant 100 can be considerably increased. This results in ascent of power plant 100 such that central bridge structure 106 reaches the water surface W. For this purpose, central bridge structure 106 is provided with air-discharging valves 152 at the upper part thereof and water inlet/outlet (for example, Kingston) valves 154 at the lower part thereof. To bring power plant 100 to its operational semi-submerged position all valves 152, 154 are opened. To bring power plant 100 to the water surface, air-discharging valves 152 are closed before blowing compressed air into the central bridge structure 106 to expel the water via valves 154. In the surfaced position all valves 152, 154 are closed.

Central bridge structure 106 has an angled configuration such that central bridge structure 106 declines from each side of the center plane 132 as an inverted V-shape. Such inclination of central bridge structure 106 allows accumulation of air in the central upper portion of the central bridge structure 106 and reduces arbitrary transverse displacements of air bubbles. In straight horizontal ballast sections, air bubbles can collect on one side and may result in list moments and transverse instability. An angled configuration avoids such instability. To effectively use the central bridge structure 106 as a ballast tank, the crest of the angled central bridge structure 106 is preferably below the waterline W while power plant 100 is surfaced.

It will be understood that the additional ballast provided by the central bridge structure 106 can also assist with the stability of power plant 100 and assist to keep turbines 104 in a position such that the tip of blades 112 stay submerged when in their upper vertical position.

Arranging turbines 104 in the vicinity of the water surface W positions them near the maximum velocities for the ocean currents, and so, maximum available power densities. Such arrangement results in a more compact power plant 100 with smaller blades 112 as compared to power plants operating at lower depths. Initial capital costs of power plant 100, as well as future maintenance costs are lower because of the turbines 104 are in closer proximity to the water surface W. All these factors combine to lower the cost of electricity generated.

In order to raise power plant 100 toward the water surface, a service boat may connect to an air socket (not shown) on upper housing 110. Air lines (not shown) extending through access shafts 108 can then supply compressed air to central bridge structure 106 and/or nacelles 102. Alternatively, nacelles 102 may carry their own compressed air source (not shown).

Power plant 100 is typically anchored securely in the flow F. Accordingly, power is generated through a hydrodynamic drag force on blades 112, which is borne by an anchoring system 157. Depending on the speed of the flow F and the characteristics of turbines 104, the loads on the anchoring system can be substantial.

Referring again to FIG. 1, illustrated therein is an exemplary anchoring system 157 for power plant 100. The anchoring system 157 includes a lug 156 located at or near the center plane 132 at a forward part of the central bridge structure 106. Lug 156 attaches to central bridge structure 106 and connects to a cable or tether 158 that attaches to the seabed.

The vertical position of lug 156 in this embodiment corresponds to the vertical position of the center of drag: i.e., the position of the resulting hydrodynamic force acting on power plant 100 in the flow direction F. Taking into consideration considerable turbine loads, and relatively small hydrodynamic drag of the power plant 100 itself, the center of drag in this embodiment is anticipated to be slightly above the axis of turbine 104 in projection to center plane 132.

The access shafts 108, nacelles 102 and central bridge structure 106 of power plant 100 can also be provided with streamlined shapes or provided with fairings 148 to reduce hydrodynamic drag. Lower drag reduces the load supported by the anchoring system 157. Fairings 148 can also reduce flow turbulence entering the aft mounted turbines 104.

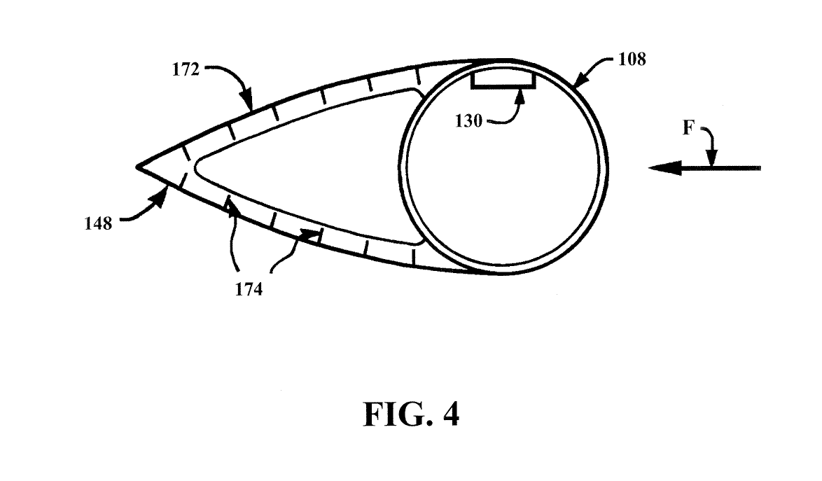

Referring to FIG. 4, fairing 148 will be described in more detail with respect to an access shaft 108. Fairing 148 is generally placed on the aft-most portion of access shaft 108 and comprises two smoothly curved panels 172 reinforced by stiffeners 174. Curved panels 172 attach tangentially to the shell of access shaft 108 along the flow direction F. Curved panels 172 meet at an appropriate point downstream of access shaft 108 based on the flow characteristics such that the curved panels 172 form a pointed trailing edge. Curved panels 172 are generally positioned symmetrically about each other along the flow direction F.

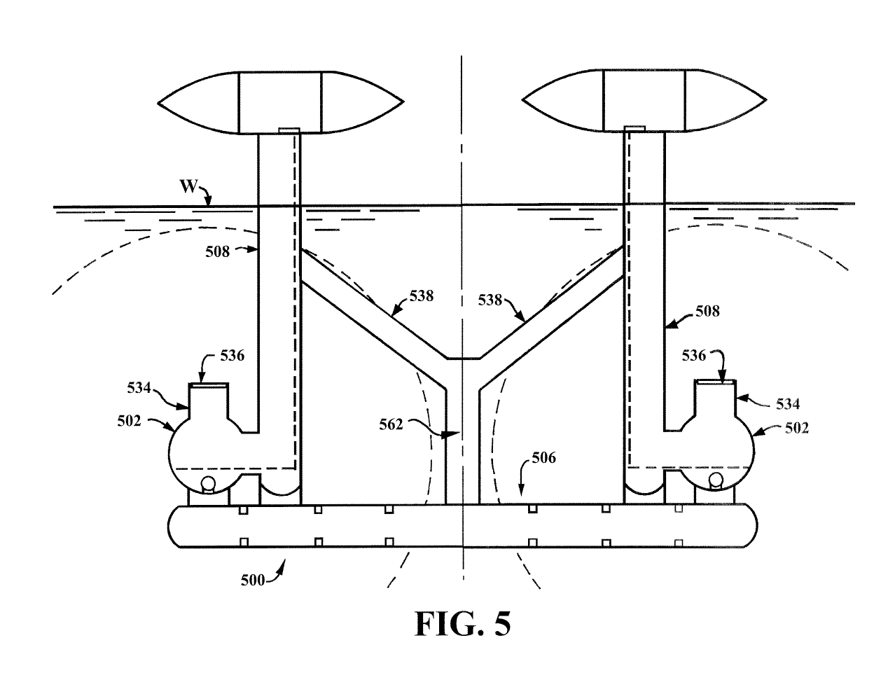

Referring now to FIG. 5, illustrated therein is a cross-sectional view of a power plant 500 according to another exemplary embodiment. Power plant 500 is generally similar to power plant 100 and corresponding elements are given similar reference numerals, incremented by 400.

In power plant 500, access shafts 508 are positioned beside nacelles 502 in order to simplify the arrangement of superstructures 534 at the upper part of nacelles 502. Since superstructures 534 are not encumbered with access shafts 508, it can be easier to use hatches 536 for loading and unloading power-generating equipment.

In this embodiment, modified central bridge structure 506 includes a straight central connection structure provided with a central vertical strut 562 extending upward to two inclined braces 538. Nacelles 502 are structurally bound by straight central bridge structure 506. Central bridge structure 506 may also act as a ballast tank similar to central bridge structure 106.

The arrangement of components of power plant 500 facilitates modular assembly and servicing. For example, nacelles 502 can be manufactured as separate modules and can then be easily mounted on or removed from straight central bridge structure 506 and access shafts 508 during manufacturing, on site, or when needed for major servicing or the like.

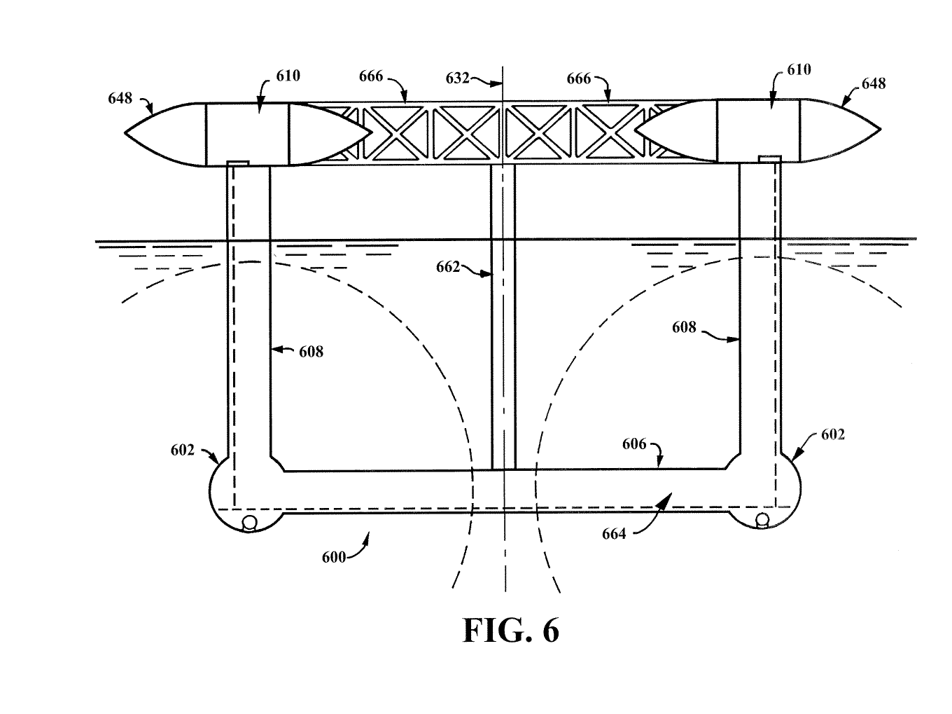

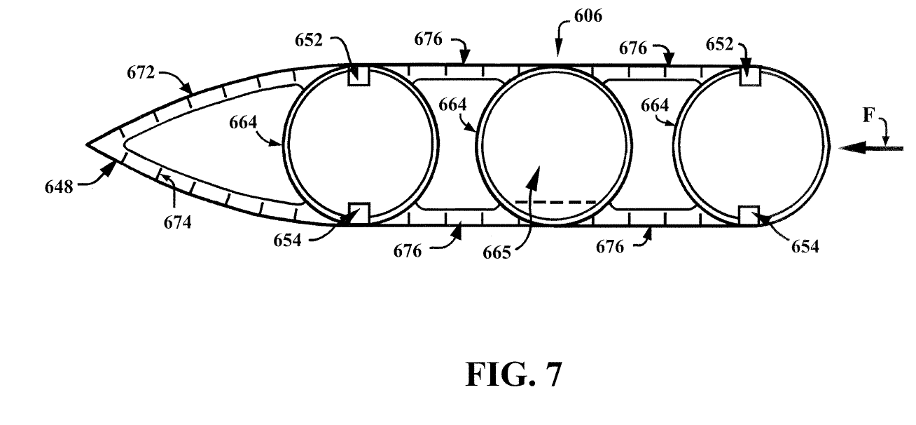

Referring now to FIGS. 6 and 7, illustrated in FIG. 6 is a cross-sectional view of a power plant 600 according to another exemplary embodiment. Power plant 600 is generally similar to power plant 100 and corresponding elements are given similar reference numerals, incremented by 500.

Power plant 600 includes a central bridge structure 606 having three transversely arranged parallel tubular structural elements 664, as shown in cross-section in FIG. 7. In this embodiment, two of the tubular structural elements 664 serve as ballast tanks and are provided with air-discharging valves 652 at the upper part thereof and water inlet/outlet (for example, Kingston) valves 654 at the lower part thereof. The third tubular structural element 664 provides a service tunnel 665 connecting nacelles 602.

Central connecting bridge structure 606 also includes a fairing 648 that mounts to the aft portion of the aft-most tubular structural element 664. Fairing 648 includes two smoothly curved panels 672 reinforced by stiffeners 674, similar to fairing 148. Upstream of fairing 648, gaps between adjacent tubular structural elements 664 receive flat reinforced panels 676. The combination of fairing 648 and flat panels 676 can reduce drag due to central bridge structure 606.

Referring again to FIG. 6, projecting from central bridge structure 606 along center plane 632 is a central vertical strut 662 that extends and attaches to an above water connection structure 666. Above water connection structure 666 also attaches to upper housings 610, adding structural stability to power plant 600. In addition, above water connection structure 666 may provide an above water passage between upper housings 610.

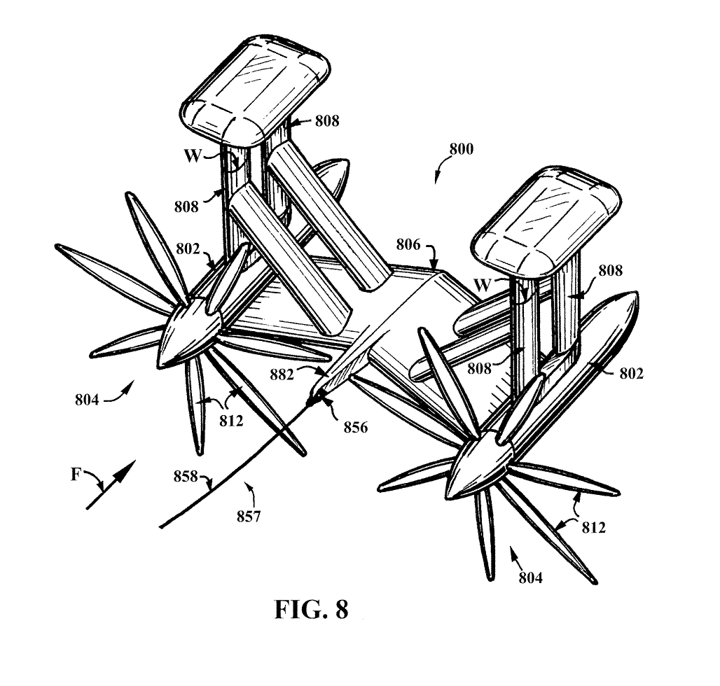

Referring now to FIG. 8, illustrated therein is a perspective view of a power plant 800 according to another exemplary embodiment. Power plant 800 is generally similar to power plant 100 and corresponding elements are given similar reference numerals, incremented by 700.

Power plant 800 includes two submerged nacelles 802, forward-mounted turbines 804 and a central bridge structure 806 having an angled shape. Nacelles 802 attach to central bridge structure 806 and each have two tubular access shafts 808 extending vertically above water surface W. A central mooring sprit structure 882 protrudes forward from central bridge structure 806 along a central plane of power plant 800.

Sprit structure 882 extends upstream beyond turbines 804. A lug 856 is provided on the forward extremity of sprit structure 882. Lug 856 connects to a cable 858 of an anchoring system 857. In this embodiment, the vertical position of the lug 856 corresponds to the vertical position of the center of drag.

Use of sprit structure 882 reduces the possibility of cable 858 becoming ensnared in the rotation of blades 812 that may otherwise damage blades 812 or cable 858. In the event that a cable 858 breaks, power plant 800 may drift leading to loss of capital cost, and potential damage to other sea vessels, among other problems. In the event that a blade 812 breaks, the blade would need replacement, involving considerable maintenance time, repair costs and downtime losses. Attaching cable 858 to sprit structure 882 avoids these and other potential problems associated with forward mounted turbines.

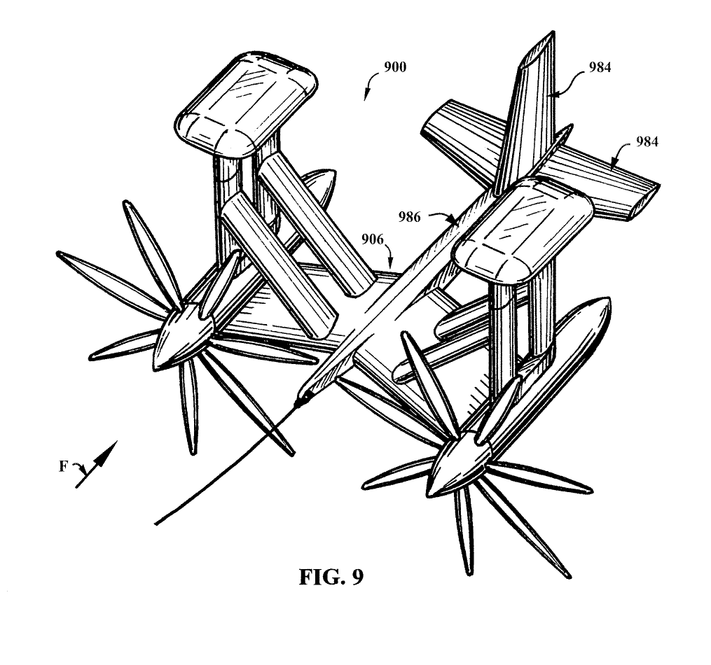

Referring to FIG. 9, illustrated therein is a perspective view of a semi-submersible power plant 900 according to another exemplary embodiment. Power plant 900 is generally similar to power plant 800 and corresponding elements are given similar reference numerals, incremented by 100. In particular, power plant 900 further includes aft stabilizers 984.

Aft stabilizers 984 include both vertical and horizontal stabilizers positioned at an appropriate distance downstream of central bridge structure 906. Aft stabilizers 984 connect to central bridge structure 906 by means of an aft spur 986 arranged at a central plane of power plant 900 and extending approximately backwards along the flow direction F from central bridge structure 906.

Aft stabilizers 984 provide additional stability for power plant 900. For example, an undesirable turn of power plant 900 in the flow relative to a vertical and/or transverse horizontal axis will yield some angle of attack on the surfaces of aft stabilizers 984. According to airfoil theory, aft stabilizers 984 will generate a hydrodynamic force related to the flow properties and angle of attack. The hydrodynamic force acts on power plant 900 through a moment arm between the center of gravity and the hydrodynamic force. This induces a moment that restores power plant 900 to an equilibrium position.

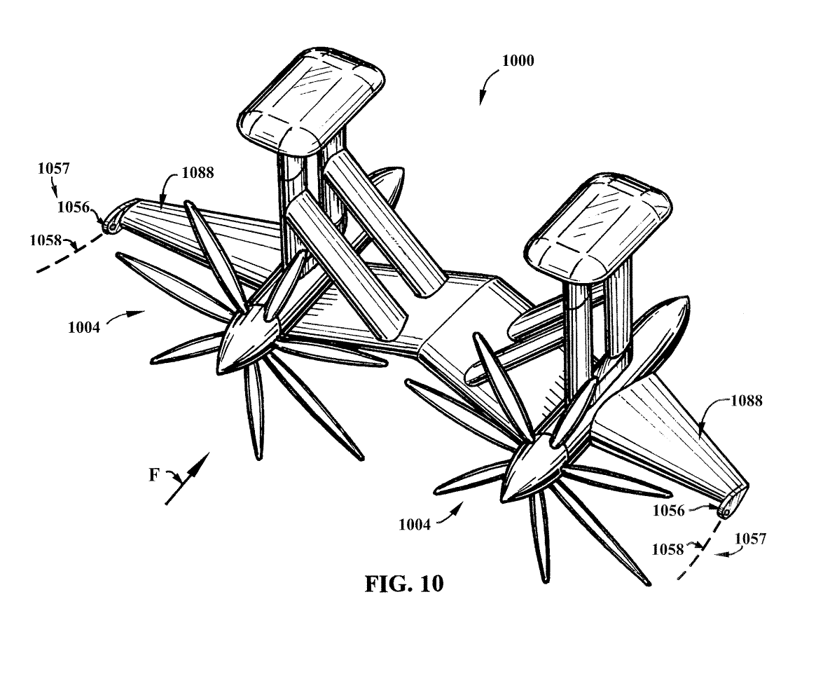

Referring to FIG. 10, illustrated therein is a perspective view of a power plant 1000 according to another exemplary embodiment. Power plant 1000 is generally similar to power plant 800 and corresponding elements are given similar reference numerals, incremented by 200. In particular, power plant 1000 does not include a central mooring sprit structure, but instead includes two lateral mooring wings 1088 intended for connection with an anchoring system 1057.

The two lateral mooring wing structures 1088 protrude outward from both sides of power plant 1000 and extend transversely beyond turbines 1004. The anchoring system includes a lug 1056 at a tip of each wing 1088 for connection to a cable 1058 for each lug 1056.

Arranging lugs 1056 and cables 1058 to the side of power plant 1000 improves position and orientation stability in the horizontal plane. The cable 1058 of each mooring wing 1088 corresponds to an anchoring zone. When anchoring with two or more cables 1058, the overlapping region of each anchoring zone further defines a range within which power plant 1000 can move. Accordingly, having more than one anchoring system can improve position and orientation stability. Furthermore, the stabilizing effect provided by such an anchoring system can be improved by positioning anchors (not shown) further from the center plane of power plant 1000 than corresponding lugs 1056.

In a situation where aft mounted turbines are desired, the use of aft stabilizers, such as those previously described, may be difficult. However, an anchoring system 1057 having two cables 1058 provides similar benefits to that of aft stabilizers with respect to orientation and position stability.

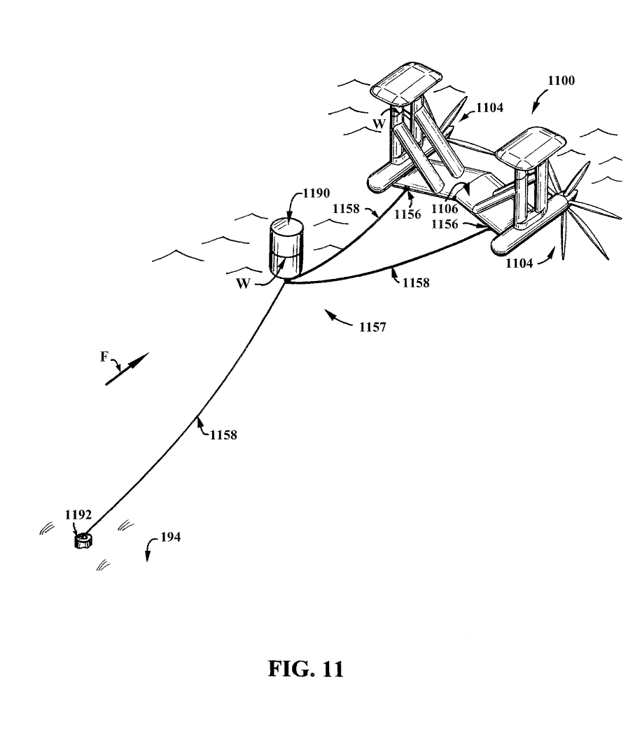

Referring to FIG. 11, illustrated therein is a perspective view of a power plant 1100 according to another exemplary embodiment. Power plant 1100 is generally similar to power plant 100 and corresponding elements are given similar reference numerals, incremented by 1000. In particular, power plant 1100 does not include a central lug 156, but instead includes a wishbone anchoring system 1157.

Power plant 1100 includes aft-mounted turbines 1104 connected by a central bridge structure 1106. The anchoring system 1157 includes lugs 1156 and cables 1158. Two lugs 1156 attach to the forward portion of central bridge structure 1106 and are disposed symmetrically about a center plane of power plant 1100. A cable 1158 attaches to each lug 1156 and cables 1158 converge at an intermediate buoy 1190. The converged cable 1158 extends to an anchor 1192 embedded in a seabed 194 to anchor power plant 1100.

The configuration of the anchoring system 1157 provides for static positioning of power plant 1100 and also has an impact on dynamic behavior. Angles of attachment of mooring cables 1158 to power plant 1100 can influence position, stability and power-generation efficiency. For instance, a vertically inclined angle of attachment may lead to transmission of vertical components of mooring force to power plant 1100. Since mooring forces for anchoring can be quite large, the resolved vertical component can also be quite large. Such vertical forces may tilt or submerge power plant 1100 to an undesirable orientation, resulting in lower efficiency. To reduce such forces, intermediate buoy 1190 raises anchoring cable 1158 up to approximately the vertical position of lugs 1156 and is intended to provide an approximately horizontal position of the cable 1158 at the point of attachment to central bridge structure 1106. Such configuration results in lower vertical components of mooring forces at lugs 1156. Accordingly, power plant 1100 operates in a more balanced and stable orientation.

Many geographical locations have ocean currents that involve reciprocating tidal currents. It will be understood that designs similar to those of the previously described embodiments can also be used for generation of electricity on the basis of kinetic energy from the periodic reciprocating flow of tidal currents. In tidal operation, a power plant can be anchored with respect to flows coming from two opposing directions to improve energy collection efficiency. In addition, turbines can also be configured to operate in flows coming from two opposing directions.

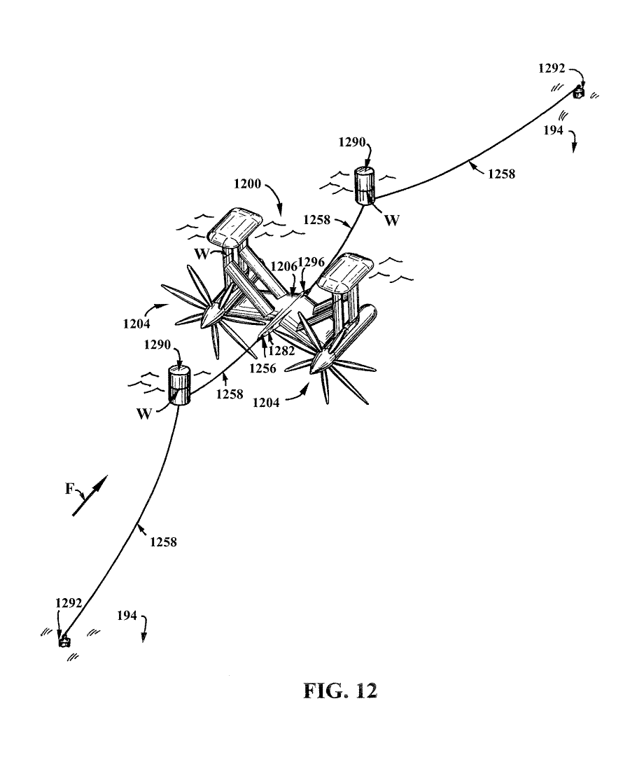

Referring now to FIG. 12, illustrated therein is a power plant 1200 according to another exemplary embodiment. Power plant 1200 is generally similar to power plant 800 and corresponding elements are given similar reference numerals, incremented by 400. In particular, power plant 1200 further includes a downstream lug 1296 in addition to a central mooring sprit 1282 and an upstream lug 1256. Accordingly, power plant 1200 is configured for operation in tidal currents.

Upstream mounted sprit structure 1282 protrudes forward from a central bridge structure 1206 along a center plane of power plant 1200. Sprit structure 1282 extends upstream beyond turbines 1204. Upstream lug 1256 is provided at the forward extremity of sprit structure 1282. Upstream lug 1256 connects to a cable 1258 that extends to an intermediate buoy 1290 and then to an anchor 1292 embedded into seabed 194.

The downstream lug 1296 attaches to a rear portion of central bridge structure 1206 along the center plane. Downstream lug 1296 connects to a cable 1258 that extends to an intermediate buoy 1290 and then to an anchor 1292 embedded into seabed 194.

The vertical position of both upstream lug 1256 and downstream lugs 1296 correspond approximately to the vertical position of the center of drag.

The above described single cable aft anchoring system can also be replaced with a multi-cable aft anchoring system, for example, the wishbone configuration shown in FIG. 11. If aft mounted turbines are used, a rear sprit structure can be used, in this case, a multi-cable forward anchoring system, as shown in FIG. 11, may also be used.

It will be understood that the anchoring system of FIG. 12 may also be applied to unidirectional surface ocean currents. In this case, the anchoring system of the present embodiment restricts transverse and angular movements, and may enhance dynamic stability of power plant 1200.

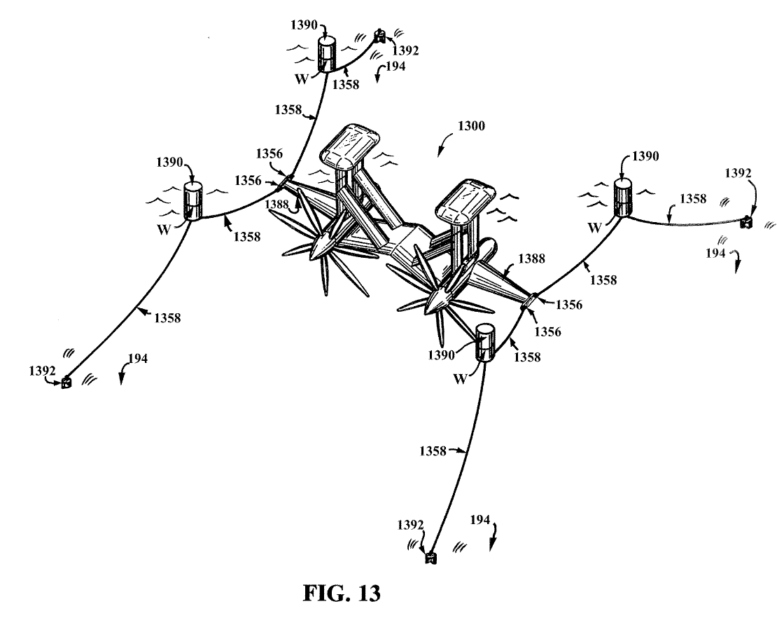

Referring now to FIG. 13, illustrated therein is a power plant 1300 in accordance with another exemplary embodiment. Power plant 1300 is generally similar to power plant 1000 and corresponding elements are given similar reference numerals, incremented by 300. In particular, power plant 1300 includes fore and aft lugs 1356 on mooring wings 1388 to allow for operation in tidal currents.

The tip of each wing 1388 has two lugs. The forward and aft lugs 1356 of each wing 1388 connect to cables 1358 of forward and aft anchoring systems respectively. Each cable extends to a buoy 1390 at or near the water surface W and attaches to an anchor 1392 embedded in seabed 194.

The vertical position of lugs 1356 generally corresponds with the position of the center of drag of power plant 1300. In this case, four anchors hold power plant 1300: two systems, having forward and aft anchors, symmetrically located about central plane 1332. Such a configuration stabilizes position and orientation of power plant 1300 when operating in both directions of a reciprocating tidal flow. The anchor system also reduces transverse movements and provides anchoring redundancy.

In application to unidirectional surface ocean currents, the anchoring system of the present embodiment restricts transverse and angular movements, and may enhance dynamic stability of power plant 1300.

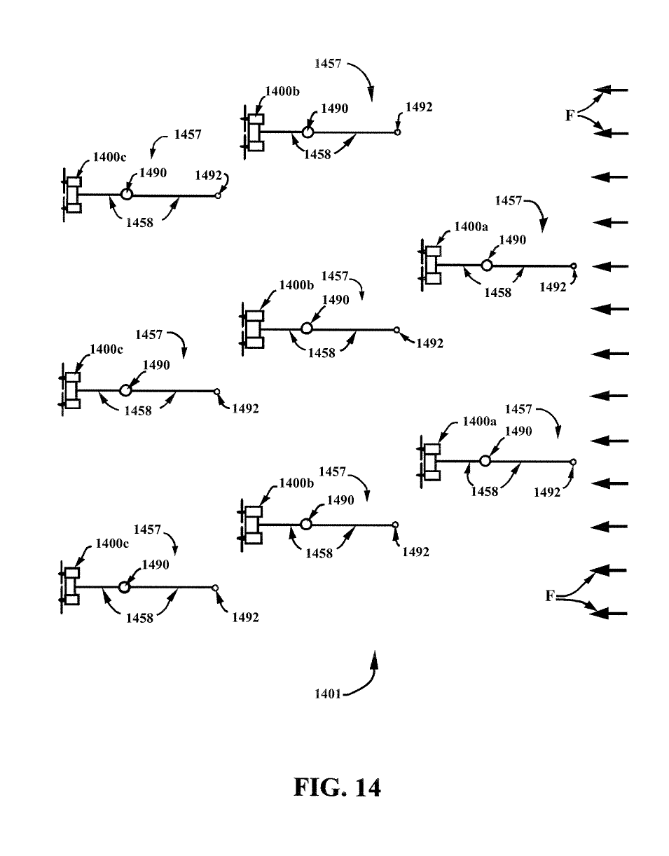

Referring now to FIG. 14, illustrated therein is a plan view of an offshore hydropower station 1401 according to another exemplary embodiment. Offshore hydropower station 1401 includes a plurality of power plants 1400 arranged in a stagger formation with respect to a flow direction F. Power plants 1400 may be any power plant, such as those previously described herein, for obtaining energy from water flow.

Power plants 1400 are anchored by anchoring systems 1457 which each include, a mooring cable 1458, an intermediate buoy 1490 supporting cable 1458, and an anchor 1492 connecting cable 1458 from buoy 1490 to seabed 194. Intermediate buoy 1490 is located at an appropriate point between power plant 1400 and anchor 1492.

Power plants 1400 form three rows arranged basically transversely to the flow direction F. Each row of power plants 1400 is separated longitudinally from one another such that there is a distance between an upstream power plant 1400a and the anchor of a downstream power plant 1400b. This arrangement reduces the risk of collisions between power plants 1400a of upstream rows with power plants 1400b of downstream rows. Furthermore, this arrangement provides access corridors for service boats (not shown) to service power plants 1400, (i.e. servicing anchors and power generating equipment) and other vessels to navigate to and from power plants 1400 of offshore hydropower station 1401.

Each power plant 1400 within a row may be in power transmitting communication with other power plants 1400 of the same row. Accordingly, power cables (not shown) may run along power plants 1400 of a particular row, connecting each power plant 1400 in that row. Preferably, the power cables run along anchors 1492 such that service boats can navigate the access corridors to service the power cables. Additional power cables (not shown) may also be provided to connect the power cables of particular rows, or to connect the hydropower station 1401 to a power grid.

Within rows, power plants 1400 are separated such that an upstream power plant 1400a does not substantially overlap a downstream power plant 1400b in projection to a plane transverse to the flow F. This arrangement improves the energy collection efficiency of the offshore hydropower station 1401.

Configuring offshore hydropower station 1401 in transverse stagger formation as described above reduces potential overlap of power plants 1400 along the flow direction F. Such a configuration of power plants 1400 improves the overall collection efficiency of energy-saturated portions of ocean currents while avoiding potential collisions between power plants 1400. If power plants 1400 were arranged in a single row, the separation necessary to avoid collision generally reduces the collection efficiency of the offshore hydropower station 1401 by allowing a portion of the ocean current to flow around and bypass power plants 1400. By introducing staggered rows, power plants 1400 remain at a safe distance regarding collision while improving the collection efficiency of the offshore hydropower station 1401 by capturing a greater portion of the ocean current flow.

In some cases, power plants 1400 may overlap in rows that are not directly adjacent to one another. For example, a power plant 1400a in a first row does not overlap with a power plant 1400b in a second row, but a power plant 1400c in a third row may have a portion overlapping with the power plant 1400a in the first row. Such an arrangement can improve collection efficiency by capturing portions of the flow that are not directly in the wake of an upstream power plant.

In an alternative embodiment (not shown), an offshore hydropower station may include two or more rows of power plants. The central axis of each power plant within a row may be set to a minimum distance from the central axis of another power plant within the same row. The minimum distance can be determined based on a minimum clearance between blades of adjacent power plants and may provide a higher collection efficiency for the offshore hydropower station than with an arrangement of power plants having a larger distance between central axes. Using this arrangement, the power plants 1400 can be tightly packed together to more efficiently collect energy from a limited size of ocean current.

Power plants made in accordance with embodiments as described herein and alternatives can be located in the vicinity of the water surface with the intention of exploiting the upper energy-saturated layers of ocean currents. As also described above, maximum velocities for ocean currents typically occur near the water surface, so, power extraction from the maximum available energy density of ocean currents is possible. It will be understood that power plants in accordance with embodiments herein and modifications thereto are generally of more compact nature and lower cost than conventional flow power extraction devices. Furthermore, power plants made in accordance with embodiments herein are expected to achieve lower per-watt capital costs, lower maintenance costs, and lower per-watt-hour costs of power generation.

In general, power plants made in accordance with the description herein are expected to provide better stability in ocean currents with respect to compensation of torque moments, natural self-stabilization, management of anchoring forces, and low dynamic response under operational conditions.

It should be apparent to one skilled in the art that various modifications can be made to the embodiments disclosed herein and various combinations of the various elements described can be made without deviating from the intended scope of the present invention, the scope of which is defined in the appended claims.

1. An apparatus configured to convert kinetic energy of water flow to electrical power, the apparatus comprising:
an axial turbine configured to be submerged under a water surface comprising:
a rotor;
an enclosure; and
a generator within the enclosure coupled to the rotor;
a shaft extending from the enclosure, wherein the shaft is configured to extend above the water surface and provide buoyancy; and
an anchor system connecting the apparatus to a stationary reference.

2. The apparatus of claim 1, wherein the apparatus is configured to have a waterline area at the water surface that is less than a predetermined multiplier times the displacement of the apparatus divided by the length of a wave having a low probability of occurring.

3. The apparatus of claim 2, wherein the predetermined multiplier is approximately five.

4. The apparatus of claim 2, wherein the wave is a characteristic wave of approximately 3% probability.

5. The apparatus of claim 1, wherein the shaft comprises an access shaft providing access to the enclosure through the shaft.

6. The apparatus of claim 5, further comprising an upper housing connected to the access shaft above the water surface.

7. The apparatus of claim 1, wherein the anchor system comprises:
an anchor to be secured to a seabed;
a connector connecting the apparatus and the anchor; and
an intermediate buoy supporting the connector between the apparatus and the anchor, wherein the intermediate buoy is configured to provide an approximately horizontal attachment of the connector to the apparatus.

8. The apparatus of claim 1, wherein the apparatus is configured such that the centre of gravity of the apparatus is below the centre of buoyancy of the apparatus.

9. An apparatus configured to convert kinetic energy of water flow to electrical power, the apparatus comprising:
a pair of axial turbines configured to be submerged under a water surface, the pair of axial turbines having parallel axes of rotation and being counter-rotating, each axial turbine comprising:
a rotor;
an enclosure; and
a generator within the enclosure coupled to the rotor;
a central bridge structure interconnecting the pair of axial turbines;
at least two shafts, wherein each of the at least two shafts attaches to a respective axial turbine and is configured to extend above the water surface such that the at least two shafts provides buoyancy; and
an anchor system connecting the apparatus to a stationary reference.

10. The apparatus of claim 9, wherein the at least two shafts have a waterline area at the water surface that is less than a predetermined multiplier times the displacement of the apparatus divided by the length of a wave having a low probability of occurring.

11. The apparatus of claim 10, wherein the predetermined multiplier is approximately five.

12. The apparatus of claim 10, wherein the wave is a characteristic wave of approximately 3% probability.

13. The apparatus of claim 9, wherein the at least two shafts comprise a first pair of access shafts and a second pair of access shafts extending from the enclosures such that the first pair of access shafts are placed symmetrically about a first plane through the center of gravity of the apparatus, and the second pair of access shafts are placed symmetrically about a second plane through the center of gravity of the apparatus.

14. The apparatus of claim 9, wherein the central bridge structure is angle shaped and has an interior cavity defining a ballast tank, the central bridge structure comprising:
an air discharge valve in an upper portion of the interior cavity; and
a water inlet/outlet valve in a lower portion of the interior cavity.

15. The apparatus of claim 9, wherein the anchor system comprises an upstream anchor system and a downstream anchor system, wherein the pair of axial turbines can operate in a forward or reverse direction with water flow alternately approaching from two opposite directions.

16. A system configured to convert kinetic energy of water flow to electrical power, the system comprising:
a plurality of apparatuses according to claim 9 wherein the plurality of apparatuses are arranged in a plurality of rows, such that an upstream apparatus of an upstream row does not overlap a downstream apparatus of a downstream row in projection to a plane transverse to the water flow.

17. A method of designing an apparatus to be semi-submerged on a water surface, the method comprising the steps of:
providing the apparatus with a center of gravity below a center of buoyancy of the apparatus, and
providing the apparatus with a waterline area that is less than a predetermined multiplier times the displacement of the apparatus divided by the length of a wave having a low probability of occurring.

18. The method of claim 17, wherein the predetermined multiplier is approximately five.

19. The method of claim 17, wherein the wave is a characteristic wave of approximately 3% probability.

20. The method of claim 17, wherein the waterline area is defined by a shaft extending from a submerged portion of the apparatus to above the water surface.
